(19) United States
(12) Patent Application Publication
(10) Pub. No.: US 2004/0095499 A1
(43) Pub. Date: May 20, 2004

(54) Imager module with a retractable lens

(76) Inventor: Alex Ning, San Marcos, CA (US)

Correspondence Address: JAMES F. KIRK, 16365 MARUFFA CIRCLE, HUNTINGTON BEACH, CA, 92649-2134, US

(21) Appl. No.: 10/714,129

(22) Filed: Nov. 13, 2003

Related U.S. Application Data
(60) Provisional application No. 60/426,119, filed on Nov. 13, 2002.

(51) Int. Cl. H04N 5/225

(52) U.S. Cl. 348/335

(57) ABSTRACT

An imager module has a retractable lens assembly that is received in a lens holder. The lens assembly is extended to an extended position for best focus in several alternative embodiments. The lens holder has an image end and an object end and an inner guide surface. An imager has an image plane, the imager is coupled to the lens holder adjacent the lens holder object end. A lens assembly has an objective lens with one or more lens elements co-axially aligned on an optical axis. The lens assembly has an image end, an object end, an optical axis, and an external guide surface. The lens assembly external guide surface is supported by the lens holder inner guide surface. The lens holder is formed to allow the lens assembly external guide surface to move on the lens holder inner guide surface from a retracted position to an extended position using a mechanical, magnetic or electromagnetic means for advancing the lens assembly to the extended position in response to an electrical signal from a mechanical or an electrical signal source.

This application is a continuation-in-part application and claims priority from parent provisional application 60/426,119 filed Nov. 13, 1902 for “An Imager Module With A Retractable Lens” having a common inventor.

### BACKGROUND OF THE INVENTION

1. Field of the Invention

The subject invention relates to objective lens-imager arrangements used in digital cameras, cell phone cameras or any digital imaging devices where a small size or short length is of primary importance.

2. Description of Related Art

Products such as digital cameras use an objective lens to capture an image and to focus the image captured on an image plane formed on the surface of a digital CCD or CMOS sensor. The length or height of the objective lens that is used establishes a lower limit for the overall thickness of the camera. The selection of the lens element material, the number of lens elements, the prescription for each lens element and the distance at which each lens element is positioned along the optical axis in front of the image plane are adjusted in the design process to obtain the sharpest image and the shortest length achievable. Each of the listed variables contribute to the lower limit of thickness that can be achieved by the designer of a digital imaging product.

### BRIEF SUMMARY OF THE INVENTION

New products, such as digital cell phones have emerged and gained popularity. The need to produce a thin, compact size imager module for many handheld applications, such as cell phone and PDA devices, has increased as the function of the cell phone has been extended to include the capture and transmission of images. The lens total track, defined as the distance from the outmost front surface of the lens to the image plane, limits how thin such an imager module can be. As the lens total track is reduced, a lower limit is penetrated beyond which the optical quality is unacceptable for many applications.

An object of this invention is to create an imager module that has a very thin profile in the non-active or retracted state. When the imager module is activated, the lens cell is moved to its best focus position by the means of a mechanical or magnetic or electromagnetic force. In the activated state, the lens is fully extended from the imager at a distance optimal for imaging. To switch to the non-activated state, the lens is retracted by the means of a reverse mechanical, magnetic or electromagnetic force. In this state, the lens is positioned in close proximity to the imager forming a very thin profile module.

### BRIEF DESCRIPTION OF THE SEVERAL VIEWS OF THE DRAWINGS

FIG. 1a is a schematic side sectional view of an imager module with a retractable lens, the retractable lens assembly shown in an extended state;

FIG. 1b is a schematic side sectional view of the lens holder in the imager module with a retractable lens of FIG. 1a, the extended lens assembly being removed from the lens holder; the spring and CCD/CMOS packages remaining;

FIG. 1c is a schematic side sectional view of the lens holder in the imager module with a retractable lens of FIG. 1a, the extended lens assembly, the spring and CCD/CMOS packages being removed;

FIG. 1d is a schematic side sectional view of the lens assembly that is within the imager module with a retractable lens of FIG. 1a;

FIG. 1e is a schematic side sectional view of the lens barrel of the lens assembly shown in FIG. 1d, the outer and inner lens barrels are shown with a flexure therebetween;

FIG. 1f is a schematic side sectional view of an objective lens that is in the lens assembly of FIG. 1d. FIG. 1f shows a three element objective lens positioned within the lens barrel;

FIG. 2 is a schematic side sectional view of the imaging module with a retractable lens assembly shown in FIG. 1a, the retractable lens assembly being shown in a retracted state;

FIG. 3 is a schematic side sectional view of an imager module with a retractable lens assembly in an extended state, the lens assembly being extended by operation of a toroidal permanent magnet;

FIG. 4 is a schematic side sectional view of the imaging module of FIG. 3 in a retracted state;

FIG. 5 is a schematic side sectional view of an imager module with a retractable lens assembly in an extended state, the lens assembly being extended by a force produced by current from an electrical signal source passing through a coil;

FIG. 6 is a schematic side sectional view of the imaging module of FIG. 5 in a retracted state;

FIG. 7 is a schematic side sectional view of the imaging module of FIG. 5 with a retractable lens assembly in an extended state, the lens assembly being extended by a force produced by a current from a signal source passing through a coil, a toroidal permanent magnet being coupled to the lens holder and polarized to hold the lens assembly in a retracted state in the absence of coil current;

FIG. 8 is a schematic side sectional view of the imaging module of FIG. 7 in a retracted state;

FIG. 9 is a schematic side sectional view of the imaging module of FIG. 5 with a retractable lens assembly in an extended state, the lens assembly being extended by a force produced by current from a signal source passing through a first coil on the lens holder and a second coil on the lens assembly;

FIG. 10 is a schematic side sectional view of the imaging module of FIG. 9 in a retracted state with no current passing through the coils;

FIG. 11 is a schematic side sectional view of an imager module with the lens assembly having three optical elements in an extended state, and with the lens holder having a stationary lens element;

FIG. 12 is a schematic side sectional view of the imaging module of FIG. 11 in a retracted state;

FIG. 13 is a schematic front view of a hand held optical appliance using an optical view finder and having an imager module with a retractable lens;

FIG. 14 is a schematic side view of the hand held optical appliance of FIG. 13 using an imager module with a retractable lens shown in the extended position;

FIG. 15a is a scaled-up by a factor of four, schematic side view of the retractable lens shown in FIG. 14 within a phantom circle, the lens assembly being shown in an extended position in phantom;

FIG. 15b is a scaled-up by a factor of four, schematic side view of the retractable lens shown in FIG. 14 within a phantom circle, the lens assembly being shown in a retracted position in phantom.

### DETAILED DESCRIPTION OF THE INVENTION

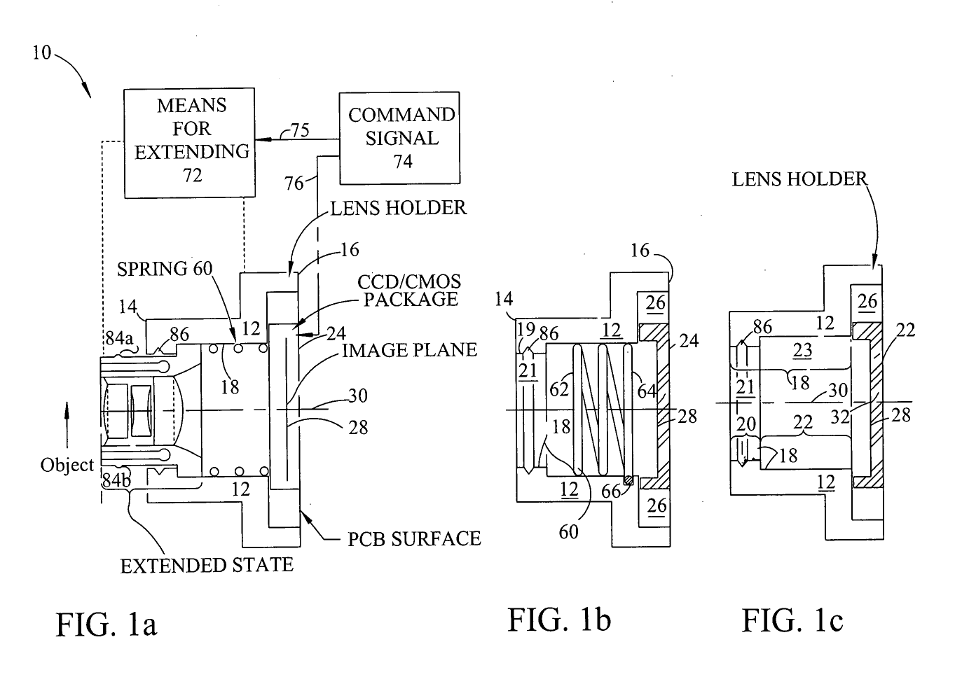

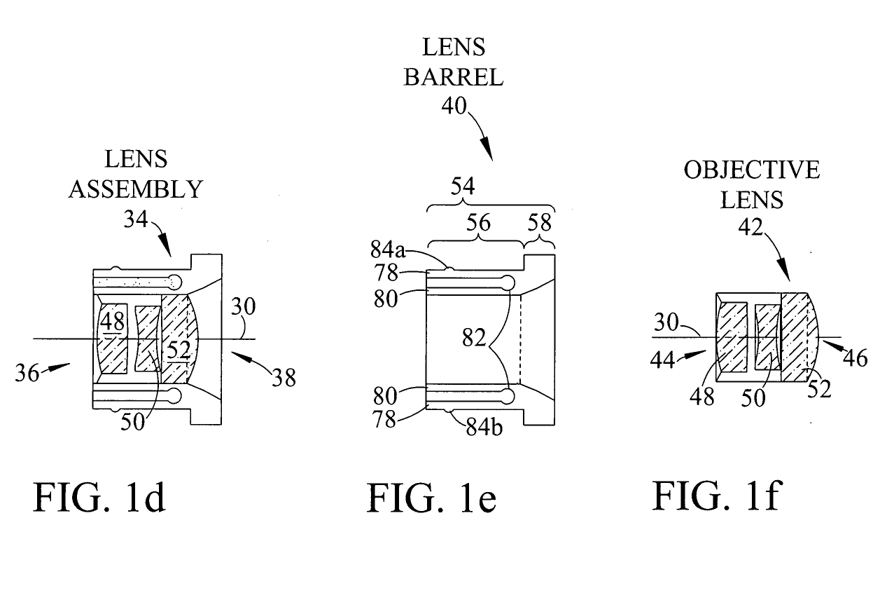

The embodiments of FIGS. 1a through 1f and FIGS. 2 through 10 illustrate several conceptual designs of the imaging module with a retractable lens assembly 10. FIG. 1a shows the imager module with a retractable lens assembly 10 in an activated or extended state. FIG. 1b through 1f explode the embodiment of FIG. 1a into its individual components to better illustrate and explain the features and terminology related to the claimed invention.

FIGS. 1b and 1c show the lens holder 12 in separate side sectional views separated from the lens assembly 10 of FIG. 1a. As shown, the lens holder has an object end 14 at its left edge and an image end 16 at the right edge. An inner guide surface 18 has a forward surface portion under bracket 20 bordering a forward cylinder or void space 21 that has a forward cylindrical aperture to the right of bracket 20. The inner guide surface 18 also has a rear surface portion under bracket 22 bordering the lens holder second cylinder or rear cylinder or void space 23 and the rear cylindrical aperture to the right of bracket 22 leading into the third cylinder 26. The lens holder forward cylindrical aperture and forward void space 21, and the rear cylindrical aperture and void space 23 receive the lens assembly 34. In the embodiment of FIGS. 1b and 1c, the forward portion or first cylinder 21 and the rear portion or second cylinder 23 are typically cylindrical in shape for ease of manufacture; however, other cross-sectional shapes are also possible if required.

A digital imager 24, such as a Kodak KAC-1310 in a CCD/CMOS PACKAGE is shown positioned in a cylindrical recess or third cylinder 26 at the image end of the lens holder 12. The digital imager 24 provides an image plane represented by surface 28. Phantom line 30 represents an optical axis that is normal to the image plane and positioned to pass through the center of the image plane 32.

FIG. 1d schematically shows the lens assembly 34 in a side sectional view. FIGS. 1e and 1f explode the embodiment of FIG. 1d into its individual components. As shown, the lens assembly 34 has an object end 36 at its left edge and an image end 38 at its right edge. The lens assembly 34 comprises a lens barrel 40 that contains an objective lens 42 which has a lens barrel 40. FIG. 1e shows the lens barrel 40 with the objective lens 42 removed. FIG. 1f shows the objective lens 42 free of the lens barrel 40.

The objective lens 42 of FIG. 1f typically has one or more lens elements. FIGS. 1d and 1f show a three element objective lens. The objective lens 42 has an object end 44 facing the object on the left, and an image end 46, facing the image plane 28. A first lens element 48, a second lens element 50 and a third lens element 52 are shown positioned and ordered on an optical axis 30. The lens barrel 40 shown in FIGS. 1a, 1d and 1e is cylindrical. FIGS. 1a and 1d show the objective lens 42 is positioned in the lens barrel 40, the vertex of each lens element being positioned on the optical axis 30. The outer surface of the lens barrel is cylindrical in shape and forms an external guide surface 54.

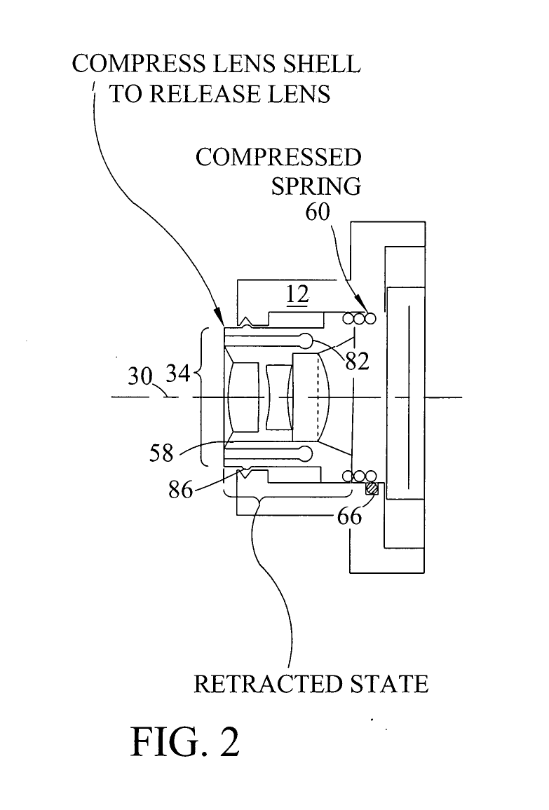

Referring again to FIG. 1e, bracket 54 shows the location of an external guide surface for the lens barrel 40. The external guide surface 54 has a forward or barrel portion under bracket 56 and a rear or flange portion under bracket 58. The flange portion under bracket 58 of the lens assembly external guide surface 54 is supported by the rear surface portion of the lens holder under bracket 22. The forward or barrel portion of the lens assembly under bracket 56 is supported by the forward surface portion of the lens holder under bracket 20. The lens holder 12 is formed to allow the lens assembly external guide surface 54 to freely and telescopically move on the lens holder inner guide surface 18 from a retracted position, such as shown in FIG. 2 to the extended position shown in FIG. 1a.

In the embodiment of FIG. 1b, the spring has an object end 62 coupled to the lens assembly image end 38 and an image end 64 coupled to the lens holder spring anchor location 66. The spring image end 64 is coupled to the anchor location by any of several conventional ways including passing a small length of the end of the spring into a recess at spring anchor location 66 or by providing an orbital recess around the wall near the inner guide surface at location 66 to receive a partial turn of the spring. As the spring expands, it drives the lens assembly 34 to the extended position or state depicted in FIG. 1a.

FIGS. 1a and 1b show that a spring 60 is coaxially positioned in the lens holder second cylinder or void space 23. As shown in FIG. 2, as the lens assembly moves to the right filling the lens holder second cylinder or rear cylindrical aperture and void space 23, spring 60 is compressed between the image end of the lens assembly and a spring anchor location 66. The lens holder first cylinder or forward cylindrical aperture and void space 21 has a recess 86 formed to receive the protrusion 86a, 86b as the lens assembly is forced into a retracted state.

Spring 60 therefore represents a mechanical means for applying a force from the lens holder 12 to the lens barrel 40 and therefore to the image side of the lens barrel or lens assembly 34 to move or advance the lens assembly 34 to the extended position of FIG. 1a in response to a command or release signal and is also therefore a means for extending the lens assembly and for holding the lens assembly in the extended position for an imaging interval during which the objective lens captures an object image, forms the object image on the image plane 28 allowing the imager 24 to capture and store the image in response to a command signal from block 74 via signal path 75. Signal line 76 schematically characterizes a path for a command signal to the control electronics within the imager 24 to command the imager control electronics (not shown) to open the gate that permits the CCD to recognize and store the image that is formed on the image plane 28. Block 72 on FIG. 1a represents a means for extending the lens assembly 34 in response to a command signal from block 74. In the alternative embodiments to follow, the means for extending represented by block 72 in FIG. 1a, will be shown to include magnetic means of both the electromagnetic and permanent magnetic types.

In the embodiment of FIGS. 1a, 1d and 1e, the lens barrel 40 has a flexible outer barrel 78 that has an outer cylindrical surface that forms a portion of the lens assembly external guide surface 54. An inner lens barrel 80 within the flexible outer barrel 78 supports one or more lens elements that form the objective lens 42.

The flexible outer barrel 78 in FIGS. 1a, 1d and 1e and 2 is coupled to the inner barrel 80 by a flexure region 82 that is designed to permit the flexible outer barrel 78 to be compressed inward toward the inner barrel 80 releasing protrusions 84a, 84b from engagement with recess 86 on the inner surface of the lens holder 12. The recess 86 can be circular or orbital or localized in one or more segments and in registration with the protrusions 84a, 84b. The protrusions are formed as a continuous protrusion around the barrel 40 or they can be segmented and located in opposing relation to pre-positioned recesses in the lens holder 12. When the flexible outer barrel 78 is released, the flexure expands the diameter of the flexible outer barrel 78 to hold a portion of the flexible outer barrel outer surface in contact with the lens holder inner guide surface.

The forward or barrel portion 56 and the rear or flange portion 58 of the lens barrel 40 separately or in combination therefore form the lens assembly external guide surface 54 in that they function to guide the lens assembly while holding its optical axis 30 normal to the image plane 28. The protrusions 84a, 84b in FIGS. 1a, 1d and 1e function as a releasable latch or pawl on engagement or entry into recess 86. The lens assembly is moved from the extended state to the retracted state manually by pressing the lens assembly into the lens holder and into a reset configuration such as shown in FIG. 2.

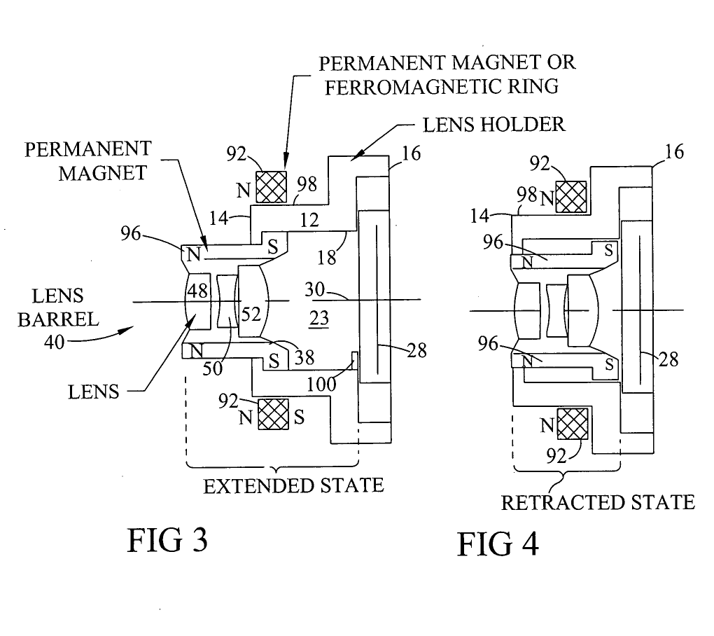

FIG. 3 shows a view of the imaging module with a retractable lens assembly 10 in an extended state. The lens assembly is extended by the axial movement of a toroidal permanent magnet 92, shaped as a ring. The ring magnet 92 is positioned to move telescopically on the lens holder cylindrical outer surface 94. The toroidal magnet has a magnetic pole of differing polarity on the object side and on the image side of the magnet 92.

The lens barrel 40 is formed to have an outer sleeve portion or outer barrel 96 that is made from permanent magnet material. If the outer barrel 96 is not made from permanent magnet material, the outer barrel 96 has at least one permanent magnet embedded in its surface to provide a magnetic field along its longitudinal axis, parallel to the optical axis 30. The permanent magnet 92 fits telescopically onto the cylindrical outer surface or lens holder outer surface 98 of the lens holder 12. The lens barrel 40 has an integral outer permanent magnet portion in or on the outer barrel 96 that is polarized to provide a magnetic field with sufficient intensity to interact with the field provided by the permanent magnet 92 to move the lens barrel 40 to an extended or a retracted position as the outer barrel 96 follows movement of the permanent magnet 92. The lens barrel 40 follows the movement of the permanent magnet 92 as it is moved toward the object or toward the image plane 28. The permanent magnet 92 and the outer barrel 96 are formed from high permeability magnetic material such as alnico or to samarium cobalt. High permeability ferrites or magnetically orientated ferromagnetic particles might be used as a filler and aligned by the application of a magnetic field to the slurry as it is allowed to harden.

In an alternative embodiment, the permanent magnet 92 is arranged to provide a low reluctance but moveable path that would transition across an air gap or other high reluctance path thereby providing a switched magnetic force function as the permanent magnet 92 ring is moved to open or to close a high reluctance gap such as an air gap. A small barrier 100 provides a travel limit stop that prevents the lens barrel 40 from reaching the digital imager 24.

In yet another alternative embodiment, the permanent magnet 92 can be segmented and reconstituted as a toroidal shape but with opposite magnetic polarity arrangements formed at opposite segments. By way of example, a segment on the toroidal circle beginning at zero degrees and terminating at 45 degrees might have a pole orientated toward the object while a segment between 180 degrees and 225 degrees might have its north pole orientated toward the image. The magnet in lens barrel 40 is positioned only on the top surface. As the toroid is rotated, the position of the north pole shown in FIGS. 3 and 4 would be switched to a south pole thereby switching the direction of the force applied to the lens barrel magnet and reversing the state of the lens barrel from an extended state to a retracted state or vice versa.

The permanent magnet shown in FIGS. 3 and 4 is in the drawing as being formed from a uniform or homogenous rare earth or ferrite material. However, small beads or buttons or tubular permanent magnets of material such as Samarium-Cobolt might be obtained from the VAC Corporation and embedded or cast in a plastic ring or switch arrangement to reverse the polarity of the poles operating on the field provided by the permanent magnets in the outer surface of lens barrel 40 or the outer barrel 78 thereby reversing the force applied to the lens barrel. A ring would permit rotation which would shift the location of the pole field or reverse the direction of the pole field depending on the configuration elected. It should be understood that the same non-symmetrical arrangement of bead, or tubular magnets in the barrel could be used to provide a similar result by rotating the lens barrel 40.

FIG. 4 shows the imaging module of FIG. 3 in a retracted state. The ring is shown in the right-most position with the lens barrel 40 trailing. The embodiments of FIGS. 3 and 4 provide a combination in which the lens barrel 40 can be made to retract and extend by pure-magnetic means. No electrical signal is required in this case. In an actual camera, the permanent magnet 92 would be moved by a mechanical toggle linked to the means for extending block 72 and it would be moved in response to a command signal as the signal was sent to the digital imager 22.

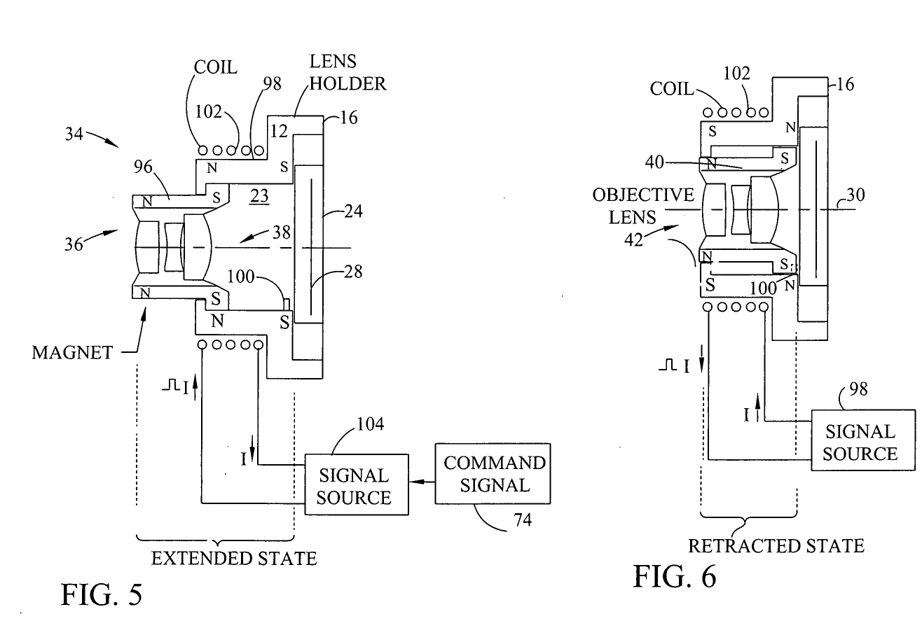

FIG. 5 shows the left or object end 36 of the outer barrel 96 magnetized to have a north or first magnetic polarity. The image end 38 of the outer barrel 96 is magnetized to have a south or second polarity. A coil 102 is wound onto the lens holder outer surface 98 to form a means for developing an electromagnetic field in the lens holder rear cylindrical aperture and void space 23 in response to a signal current “I” passing through the coil 102 from a signal source or power source 104. The current is gated on for a predetermined interval in response to a COMMAND signal from the command signal source 74 or from some other signal source preparatory to activating the electronic imager 24 to capture and save the image on the image plane 28. The polarity of the electromagnetic field produced by coil 102 and the polarities of the magnets at the object end 34 and at the image end 38 of the outer barrel 96 in the outer barrel 96 are ordered as shown in FIG. 5 to produce a force to move the lens assembly 34 to the fully extended position shown.

The current or signal source means 104 is typically a pulsed current source. The signal source 104 provides the pulse of current to the coil in response to an operator initiated image capture command signal via block 74 to the signal or pulse current source 104. The electrical signal duration and the coil current amplitude are selected to drive the lens assembly to a fully extended position during an image capture interval. At the completion of the image capture interval, the signal source 102 reverses the direction of current in the coil to restore the lens assembly to a retracted state.

FIG. 6 shows the electrical signal source 104 with the direction of the drive current through coil 102 reversed at the conclusion of the image capture interval to drive the lens assembly to the retracted state.

A mechanical stop 100 is provided between the lens assembly and the lens holder to limit the range of the motion of the lens assembly in the retracted state. The lens assembly travel is therefore limited to two positions. In the activated or extended state, the lens assembly 34 is fully extended from the imager 24 or CCD/CMOS Package. The distance between the image plane 28 and the objective lens 42 in lens barrel 40 is precisely controlled when the lens assembly is extended so that the image for capture is sharply formed on the image plane 28. In the retracted state, the lens assembly 34 is in close proximity to the imager 24. In this state, the overall height of the imager module with a retractable lens is minimized.

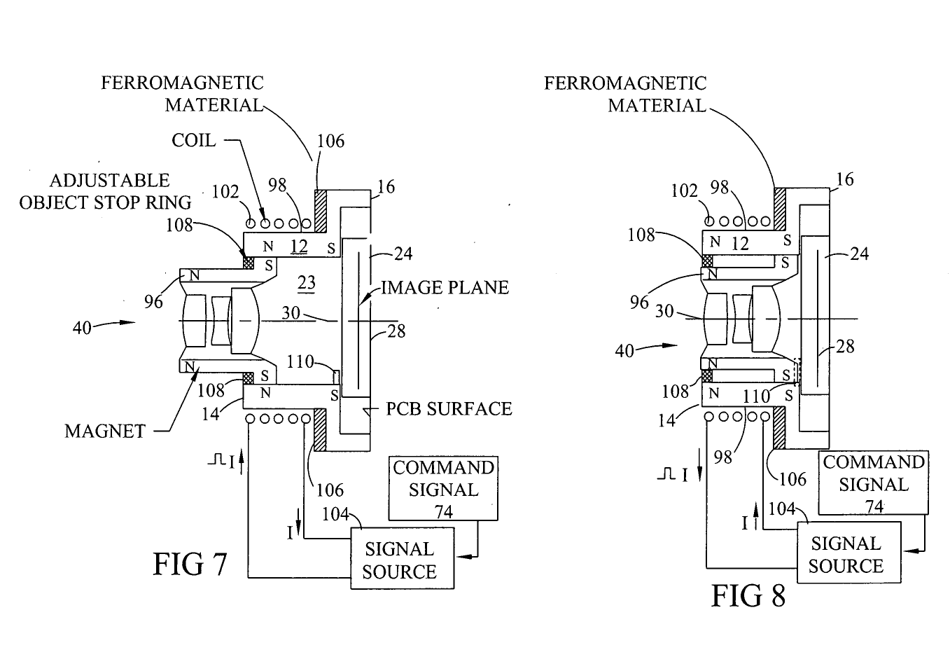

FIGS. 7 and 8 show a ferromagnetic ring of material 106 placed near the imager end 16 of the lens holder 12. As in the case of the embodiment of FIGS. 5 and 6, a coil 102 is wound onto the lens holder outer surface 98 to form a means for developing an electromagnetic field in the lens holder rear cylindrical aperture and void space 23 in response to a pulse of signal current “I” passing through the coil 102 from a signal source or power source 104. The current is gated on for a predetermined interval in response to a COMMAND signal from the command signal source 74 or from some other signal source preparatory to activating the electronic imager 24 to capture and save the image on the image plane 28. The polarity of the electromagnetic field produced by coil 102 and the polarities of the magnets at the object end 34 and at the image end 38 of the outer barrel 96 are ordered as shown in FIG. 5 to produce a force to move the lens assembly 34 to the fully extended position shown.

In the de-activated state, the ferromagnetic ring of material 106 attracts the lens barrel 40 to the imager without any current applied to the coil. A pulse of current “I” is applied to move the lens to the extended position during the image capture or picture taking interval. In the activated state, the electromagnetic field produced by the current “I” passing through the coil 102 has sufficient strength to cause the lens to move away from the CCD/CMOS Package 24 and to an extended state as shown in FIG. 7.

An advantage of this embodiment is that current is required only during the short picture taking or image capture process. Current is not required when the lens assembly is in the retracted position.

An adjustable object stop ring 108 and an adjustable image stop ring 110 are fabricated to screw into opposing ends of the lens holder 12 to adjust the extended or retracted positions of the lens assembly 34. The axial position of each ring is adjusted to provide the best focus when the lens is stopped against it. The stop rings 108 and 110 also allows fine tuning of the focus for each imager module produced.

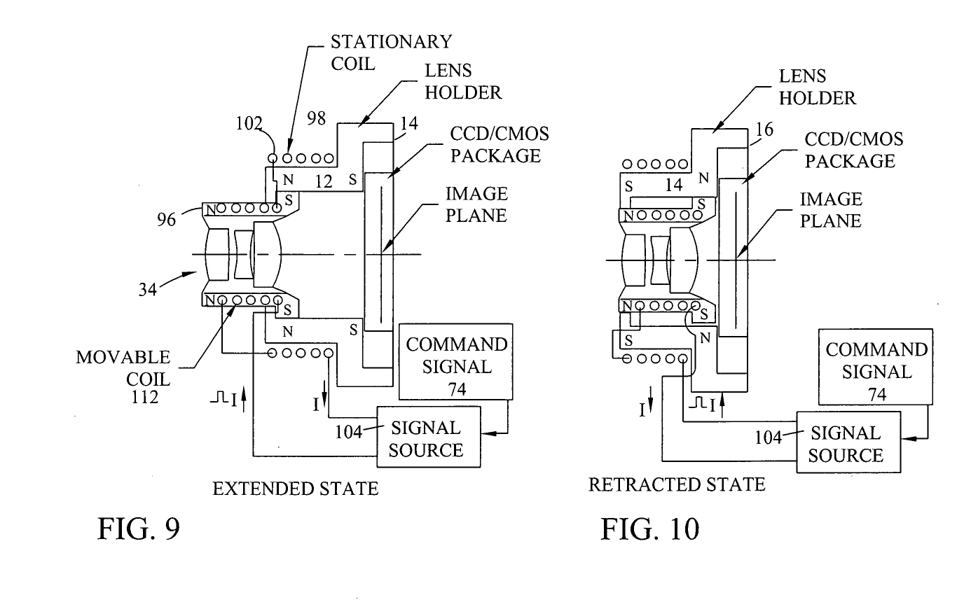

FIGS. 9 and 10 provide an arrangement in which the lens assembly 34 is made to extend or retract by the interaction between two electromagnets. A movable coil 112 is wound on the outer barrel 96, the outer surface of the lens barrel 40. The movable coil 112 is formed on the surface of the outer barrel 96 within a non-ferromagnetic protective sleeve or tube (not shown). As with the embodiments of FIGS. 5, 6, 7 and 8, a coil 102 is formed on the lens holder outer surface 98.

The combination of the moveable coil 112 with lens holder coil 102 form a means as with the embodiments of FIGS. 5, 6, 7 and 8 for developing an electromagnetic field in the lens holder rear cylindrical aperture and void space 23 in response to a first portion of a pulse of signal current “I” passing through the coil 102 from a signal source or power source 104. A second portion of the pulse of signal current “I” passes through the movable coil 112. The currents in each of the coils produce a respective flux field with a pole polarity. As shown in FIG. 9, the sense of the coil windings and the direction of the currents driving each of the respective coils is such as to produce a repulsive force that drives the lens assembly 34 toward the object into an extended position. As with the embodiments of FIGS. 5-8, the current “I” is gated on for a predetermined interval in response to a COMMAND signal from the command signal source 74 or from some other signal source preparatory to activating the electronic imager 24 to capture and save the image on the image plane 28. The polarity of the electromagnetic field produced by the movable coil 112 and the coil 102 are ordered as shown in FIG. 9 to produce a force to move the lens assembly 34 to the fully extended position shown.

FIG. 10 shows the direction of the pulse current “I” reversed. As in the case of FIG. 6, at the conclusion of the capture interval, the direction of the pulse current “I” is reversed to reverse the direction of the force applied to the lens assembly 34 to move the lens assembly back to the retracted or restored position. The advantage of the configuration of FIGS. 9 and 10 is that they eliminate the use of permanent magnet material in the manufacturing process. It should be understood that coil winding is a well established art in the instrument field and as such coils can be preformed in coil forms or tubes for use as either a moveable coil 112 or a lens holder coil 102. It should also be understood that reference to the outer barrel 96 can include a region of the lens barrel 40 and that the tooling might be developed to form the lens assembly as a molded assembly with the lens elements embedded into an integral and homogenous lens barrel 40. In such an arrangement, pre-manufactured magnets could be embedded in the outer surface of the lens barrel 40 to provide the function of a magnetized outer barrel 96.

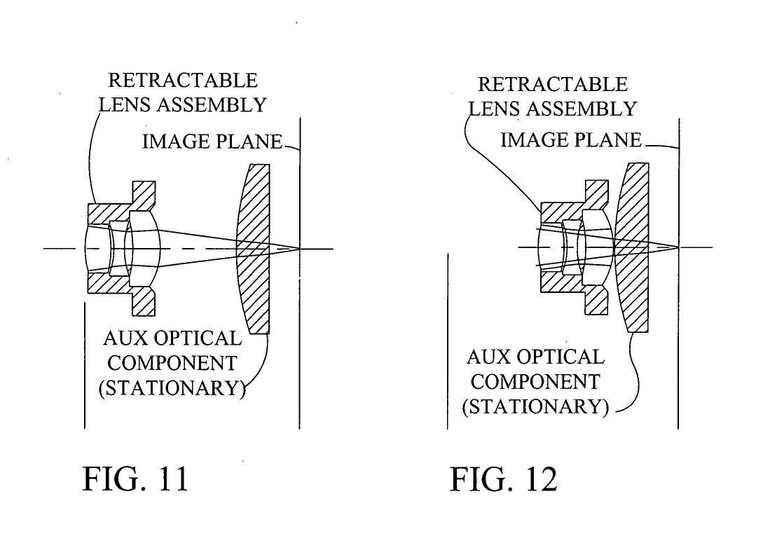

FIG. 11 is a schematic side sectional view of an imager module with a retractable lens in which the lens assembly 34 has three optical elements and is depicted as being in an extended state. A single stationary aux optical component lens is shown. The stationary aux lens is coupled to the lens holder 12 (not shown). The purpose of this figure in combination with FIG. 12 is to show that a lens assembly 34 can be extended and retracted using the embodiments shown in FIG. 1a through FIG. 10 with a portion of the lenses that comprise the objective lens while some of the lenses, such as the aux optical component shown in FIGS. 11 and 12 remain fixed in position.

FIG. 12 is a schematic side sectional view of the imaging module of FIG. 11 with the lens assembly 34 shown in a retracted state.

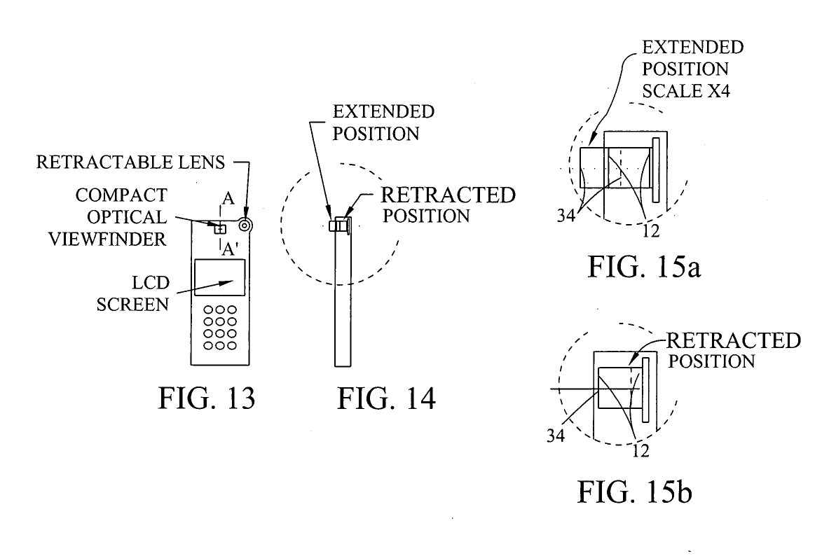

FIG. 13 shows the front view of a handheld appliance in which a retractable lens appears in the held appliance.

FIG. 14 shows the handheld appliance in side view. A phantom circle captures the retractable lens for the scaled up and expanded view of FIG. 15.

FIG. 15a is an expanded view of the retractable lens shown in FIG. 14 showing the lens assembly 34 in its extended position with the lens holder portion 12 remaining in the camera.

FIG. 15b is an expanded view of the retractable lens shown in FIG. 14 showing the lens assembly 34 in its retracted position within the lens holder 12, the reduced height contributing to a cell phone envelope that is thinner than if the lens assembly had been allowed to remain extended.

Those skilled in the art will appreciate that various adaptations and modifications of the preferred embodiments can be configured without departing from the scope and spirit of the invention. It is to be understood that the invention may be practiced other than as specifically described herein, within the scope of the appended claims.

What is claimed is:

1. An imager module with a retractable lens comprising:
a lens holder having
an image end and an
object end and
an inner guide surface, parallel to
an optical axis,
an imager having
an image plane, the imager being coupled to the lens holder adjacent the lens holder image end and aligned to position the image plane to be normal to the optical axis,
a lens assembly having
an object end, and
an image end,
an external guide surface,
the lens assembly being coupled to the lens holder by the lens holder inner guide surface being coupled to the lens assembly external guide surface, the lens holder being formed to allow the lens assembly external guide surface to move on the lens holder inner guide surface from a retracted position to an extended position,
an objective lens with one or more lens elements concentrically aligned along and normal to the optical axis; and,
a means for extending the lens assembly and for holding the lens assembly in the extended position for an imaging interval during which the objective lens captures an object image, forms the object image on the image plane allowing the imager to capture and store the image in response to a command signal.

2. The imaging module of claim 1 wherein the lens assembly further comprises:
a lens barrel, having a cylindrical external surface shape, the lens barrel holding at least the objective lens first lens element centered on the optical axis to form the objective lens, the eternal guide surface being formed on a lens barrel external surface for engagement with the lens holder inner guide surface.

4. The imaging module of claim 3 wherein the lens barrel forward portion further comprises an outer barrel having an outer cylindrical surface that forms the lens assembly external guide surface, and an inner lens barrel within the outer barrel, the inner barrel is coupled to support and locate the one or more lens elements forming the objective lens, the outer barrel and the inner barrel are coupled together at a flexure formed between the outer barrel and the inner barrel, the flexure being characterized to hold a portion of the outer barrel outer surface in contact with the lens holder inner guide surface.

5. The imaging module of claim 4 wherein the imaging module further comprises:
a spring having an object end coupled to the lens barrel image end and an image end coupled to the lens holder, the spring is contained in the lens holder second cylinder, the spring expands to apply a force to the image end of the lens assembly flange driving the lens assembly to an extended state.

6. The imaging module of claim 4 wherein the flexible outer barrel outer cylindrical surface is further characterized to have a protrusion adjacent the flexible outer barrel, and the lens holder inner surface is further characterized to have a recess formed to receive the protrusion as the lens assembly is forced into a retracted state, the lens holder first and second cylinders receiving the lens assembly, the spring being compressed in the lens holder second cylinder as the lens assembly is moved into a retracted position.

7. The imaging module of claim 4 wherein the lens assembly outer barrel is magnetized have:
an object end magnetic pole having a first magnetic polarity and an image end magnetic pole having a second magnetic polarity, and wherein:
the lens holder has an external surface, the lens holder having a coil coupled to the lens holder external surface for forming an electromagnetic field in at least the lens holder first or second cylinder in response to an electrical command signal, the polarity of the electromagnetic field and the polarity of the image end magnet pole and the object end magnetic pole being ordered to produce a force to move the lens assembly to a fully extended position.

8. The imaging module of claim 1 wherein the lens assembly barrel has an object end magnetized to form an object end magnet pole having a first magnetic polarity and an image end magnetic pole having a second magnetic polarity,
the lens holder having an external surface,
a coil means coupled to the lens holder external surface for forming an electromagnetic field in the lens holder first cylindrical aperture in response to an electrical signal, the polarity of the electromagnetic field and the polarity of the image end magnet and the object end magnet being ordered to produce a force to move the lens assembly to a fully extended position.

9. The imaging module of claim 1 wherein the means for extending the lens assembly and for holding the lens assembly in the extended position for an imaging interval further comprises:
a lens barrel outer surface having a permanent magnet coupled to its surface,
a non-fero-magnetic ring axially positioned on a circular lens holder outer surface and free to rotate, the ring having at least two permanent magnets to be coupled to the ring on opposing radials to permit the polarity of the magnetic pole applied to permit the magnet in the lens barrel to be reversed by rotation of the ring.

10. The imaging module of claim 1 wherein the means for advancing the lens assembly to the extended position in response to an extend signal is provided by a compressed spring having an object end pressing to the lens barrel image end and an image end coupled to the lens holder, the spring is contained in the lens holder second cylinder, the spring expanding to apply a force to the image end of the lens barrel flange to drive the lens assembly to an extended state, and wherein the means for retracting the lens assembly to a retracted position is a manually applied force to the lens barrel to drive the lens barrel into the lens holder first and second cylinders.

11. The imaging module of claim 1 wherein the means for advancing the lens assembly to the extended position in response to an extend signal and for retracting the lens assembly to a retracted position is a permanent magnet combination.

12 The imaging module of claim 1 wherein the means for extending the lens assembly and for holding the lens assembly in the extended position for an imaging interval during which the objective lens captures an object image, forms the object image on the image plane allowing the imager to capture and store the image in response to a command signal further comprises:
a coil on the lens holder coupled to a signal source to receive a pulse of current having a first polarity from the signal source, the current in the coil producing a magnetic field in the lens holder first and second cylinders, the lens assembly having
a lens barrel having a cylindrical external surface shape, the lens barrel having a permanent magnet formed therein, the permanent magnet being orientated to be repulsed by the magnetic field having a first polarity to drive the lens assembly to an extended position.

13 The imaging module of claim 1 wherein the means for advancing the lens assembly to the extended position in response to an extend signal and for retracting the lens assembly to a retracted position in response to a retract signal is an electromagnetic-magnetic means and further comprises:
a coil on the lens holder connected in series with a coil on the lens assembly (outer barrel) responsive to a signal source responsive to an extend signal and a retract signal for providing the direction of a pulse current through the coil on the lens holder and the lens assembly.

14 An imager module with a retractable lens comprising:
a lens holder having
an image end and an
object end and
an inner guide surface, parallel to
an optical axis,
an imager having an image plane, the imager being coupled to the lens holder adjacent the lens holder image end and aligned to position the image plane to be normal to the optical axis,
a lens assembly having
an object end, and
an image end,
an external guide surface,
a lens barrel having an external guide surface,
the lens assembly being coupled to the lens holder by the lens holder inner guide surface being coupled to the lens assembly external guide surface, the lens holder being formed to allow the lens assembly external guide surface to move on the lens holder inner guide surface from a retracted position to an extended position,
an objective lens with one or more lens elements concentrically aligned along and normal to the optical axis; and,
a coil on the lens assembly and a coil on the lens holder outer surface, the coils being connected in series to provide a repulsive force to drive the lens barrel to an extended state in response to an extend signal and to a retracted state in response to a retract signal.

15. A handheld device having an extendable imager, the extendable imager comprising:
a lens holder having
an image end and
an object end and
an inner guide surface,
an imager having an image plane, the imager being coupled to the lens holder adjacent the lens holder image end,
a lens assembly having an objective lens with one or more lens elements and an optical axis, the lens assembly having
a lens barrel holding at least one lens,
an image end,
an object end,
an optical axis and
an external guide surface, the lens assembly external guide surface being supported by the lens holder inner guide surface, the lens holder being formed to allow the lens assembly external guide surface to move on the lens holder inner guide surface from a retracted position or latched position to an extended or unlatched position,
a means for advancing the lens assembly to the extended position in response to an extend signal.

16. The handheld device of claim 15 wherein the means for advancing the lens assembly to the extended position in response to an extend signal comprises:
a lens barrel having at least one permanent magnet embedded therein,
a ring positioned and formed to rotate on the lens holder, the ring having at least one magnet embedded therein, the magnet in the barrel and the magnet in the ring providing a field to drive the lens barrel into an extended mode in response to the ring being rotated to have the field of the magnet embedded in the ring repulse the field provided by the magnet in the lens barrel.
